(19) United States
(12) Patent Application Publication
(10) Pub. No.: US 2025/0041845 A1
(43) Pub. Date: Feb. 6, 2025

(54) TEST STRIP FOR MEASUREMENT OF A CONCENTRATION OF PERACETIC ACIDS AND METHOD FOR PROVIDING A COATING TO A TEST STRIP

(71) Applicant: Olympus Winter & Ibe GmbH, Hamburg (DE)

(72) Inventors: Alexander Werner, Bielefeld (DE); Martin Schnieders, Bielefeld (DE); Celina Werner, Bochum (DE); Gregor Goldberg, Warendorf (DE)

(73) Assignee: Olympus Winter & Ibe GmbH, Hamburg (DE)

(21) Appl. No.: 18/792,820

(22) Filed: Aug. 2, 2024

Related U.S. Application Data
(60) Provisional application No. 63/530,492, filed on Aug. 3, 2023.

(51) Int. Cl. B01L 3/00

(52) U.S. Cl. CPC B01L 3/5023; B01L 2300/0825; B01L 2300/16

(57) ABSTRACT

A test strip for measurement of a concentration of peracetic acids. The test strip including: a body; a test surface disposed on the body and configured to react with a liquid containing peracetic acids; and a coating covering at least the test surface.

### CROSS-REFERENCE TO RELATED APPLICATION

The present application is based upon and claims the benefit of priority from U.S. Provisional Application No. 63/530,492 filed on Aug. 3, 2023, the entire contents of which is incorporated herein by reference.

The present application is related to the following co-pending U.S. Applications, each filed on Aug. 2, 2024, U.S. patent application Ser. No. 18/xxx,xxx (corresponding to U.S. Provisional Patent Application 63/530,490); U.S. patent application Ser. No. 18/xxx,xxx (corresponding to U.S. Provisional Patent Application 63/530,496); U.S. patent application Ser. No. 18/xxx,xxx (corresponding to U.S. Provisional Patent Application 63/530,500); and U.S. patent application Ser. No. 18/xxx,xxx (corresponding to U.S. Provisional Patent Application 63/530,504); the entire contents of each of which is incorporated herein by reference.

### BACKGROUND

### Field

The present disclosure relates to a test strip for measurement of a concentration of peracetic acids. Further, the present disclosure relates to a method for providing a coating to a test strip for measurement of a concentration of peracetic acids.

### Prior Art

Test strips, in particular test strips for measurement of a concentration of peracetic acids, are often used in analysis units for detecting cleaning, sterilization and/or disinfection agents. Such analysis units may be used, for example, in water-bearing household appliances are known, for example, from DE 102009027950 A1. This document relates to a household device having a control device for performing rinse cycles, which are adjusted by the control device using cleaning agents e.g. additives. An analyzing unit detects the cleaning agents and is provided with a reading unit for radio frequency identification of barcode or other identification marks printed on the cleaning agents. The analyzing unit is connected with the control device for transmitting analyzing data from the analyzing unit to the control unit.

Furthermore, EP 3302210 B1 discloses a device and a method for determining the composition of the dirt load in a rinsing or detergent solution in a water-using household appliance, for example in a dishwasher, using near infrared spectroscopy (NIR).

Patent application DE 19806559 B4 discloses a method involving emitting rays into a dish stack, determining and/or recording a quantity or rays of at least one wavelength range, leaving the stack under respectively one predetermined angle, assuming a kind and a concentration of a pollution ratio and/or a cleaner ratio of the dish stack, and optimizing a dish washer program, accordingly. A corresponding dish washer arrangement is also disclosed.

Patent application DE 102007011119 A1 relates to a washing machine with an automatic controller for washing process and optical sensor devices. The optical sensor devices transmit signals, which are evaluated for controlling the washing process. The optical sensor devices detect light intensities of different spectral regions. The optical sensor devices are sensitive over the entire spectral region from infrared to ultraviolet. The optical sensor devices are arranged at a bypass such that the optical sensor devices measure characteristics of detergent components in different positions.

Existing solutions to use test strips for measurement of a concentration of peracetic acids, in analysis units for detecting cleaning, sterilization and/or disinfection agents, however, usually are comparatively expensive and often require the use of specialized chemicals. Further, existing solutions are often operated fully or partly manually and/or are not always accurate and robust against operating errors. For example, existing test strips are often not suitable or reliable enough for specific areas of application.

### SUMMARY

Therefore, an object is to provide a solution, which reduces or eliminates one or more of the above-mentioned disadvantages. For example, an object is to provide an improved test strip and an improved method for producing the test strip, such as a test strip, which is reliable, cost-efficient, and less sensitive to storage and operation errors.

According to an embodiment, it is provided a test strip for measurement of a concentration of peracetic acids, comprising a test surface configured to react with a liquid containing peracetic acids and covered by a coating.

The test strip described herein can be used for measuring a concentration of reprocessing agents in a reprocessing liquid used in a reprocessing apparatus for medical instruments, such as in an evaluation unit, for example comprising an optical spectrometer and/or an RGB color sensor, of a measurement system of an arrangement for measuring a concentration of reprocessing agents in a reprocessing liquid used in a reprocessing apparatus for medical instruments.

Reprocessing as used herein may comprise all steps necessary to reuse previously used medical instruments, including removing blood, tissue and other biological debris and inactivating infectious microorganisms and/or viruses. For example, reprocessing may encompass, but is not limited to, initial basic and subsequent thorough cleaning, and/or disinfecting, and/or sterilizing the medical instruments using suitable cleaning, and/or disinfecting, and/or sterilizing agents. Reprocessing may also encompass re-packaging and of terminally sterilizing the previously cleaned, and/or disinfected, and/or sterilized medical instruments. Reprocessing agents may comprise reprocessing chemicals, for example peracetic acids. A reprocessing cycle may encompass a procedure, carried out, for example, in a reprocessing apparatus, used to reprocess a medical instrument between two uses. A reprocessing cycle may encompass a process of cleaning and/or rinsing and/or disinfection and/or sterilization.

Medical instruments as used herein can encompass endoscopes and/or probes, for example, and further specified medical instruments that may be reusable, such as reusable endoscopes and/or reusable probes.

The reprocessing of medical instruments is particularly sensitive for the safety of medical procedures using such medical instruments and thus highest requirements for the reliability of such reprocessing apply. For example, the requirements in reprocessing medical instruments differ from and exceed those for water-bearing household appliances, such as dishwashers and washing machines, by far and significantly. Therefore, solutions for such water-bearing household appliances are not suitable or sufficient for the requirements applying to the reprocessing of medical instruments between different medical procedures on different patients.

In the following, initially the test strip for measurement of a concentration of peracetic acids and its components, functions and advantageous embodiments will be described.

The test strip provided herein has a test surface configured to react with a liquid containing peracetic acids. This renders the test strip suitable for measuring a concentration of reprocessing agents in a reprocessing liquid. Further, the test surface can be covered by a coating. This coating can serve to protect the test surface, such as from adverse environmental conditions that may occur during storage and/or use and may impair test accuracy.

The test strip for measurement of a concentration of peracetic acids can have several advantages. For example, the test strips are a cost-efficient way to measure the concentration of peracetic acids during or after a reprocessing cycle. They are furthermore easy to use for human operators or may be usable with specialized machinery.

The coating of the test strip for measurement of a concentration of peracetic acids can be configured to reduce the reactivity of the test surface with ambient humidity and/or air humidity. This can have an advantage of protecting the test strip from ambient humidity during storage, which may be detrimental to test accuracy and may even render the test strip unusable.

According to an embodiment, the coating of the test strip for measurement of a concentration of peracetic acids is a foil. Using a foil coating has the advantage of using an easily processable material. Foil material has further the advantage of being easy to handle and to apply. Further, a process of applying a foil coating may be open to using different kind of foils with different kinds of properties, so that the protection characteristics of the foil coating can be easily adopted to the requirements of specific areas of application.

The coating of the test strip for measurement of a concentration of peracetic acids can comprise a liquid soluble material, such as a water soluble material and/or the coating can comprise a biodegradable material. This embodiment can allow a measurement after a pre-determined period of the test strip being submerged into or exposed to a liquid.

In a further embodiment, the coating of the test strip for measurement of a concentration of peracetic acids can comprise polyvinyl alcohol. This can be an advantageous and cost-effective material.

The coating of the test strip for measurement of a concentration of peracetic acids can cover at least a portion of one side of the test strip, such as a portion of the side of the test strip containing the test surface. This can protect the test surface without excessive use of material for the coating.

The coating of the test strip for measurement of a concentration of peracetic acids can cover at least a portion of the test strip surrounding the test surface. This embodiment can use a minimal or minimized amount of material for the coating.

In an embodiment, the coating of the test strip for measurement of a concentration of peracetic acids can cover all sides of the test strip along a length section of the test strip containing the test surface. For example, the coating of the test strip for measurement of a concentration of peracetic acids can cover the whole test strip, for example, all sides of the whole test strip.

This can have the advantage of protecting the test surface particularly well from outside influences, such as humidity. Further, covering all sides or the whole test strip may be advantageous when submerging the test strip, or at least a portion thereof, with the test surface into liquid coating material for applying the coating.

In further embodiments, the length section covered by the coating of the test strip for measurement of a concentration of peracetic acids can be at least 5% of the total length of the test strip, such as at least 10%, at least 15%, at least 20%, at least 25%, at least 30%, and at least 40%.

In further embodiments, the length section covered by the coating of the test strip for measurement of a concentration of peracetic acids can be a maximum of 80% of the total length of the test strip, such as a maximum of 75%, a maximum of 70%, a maximum of 60%, a maximum of 50%, a maximum of 40%, and a maximum of 30%.

Individual or all embodiments relating to a test strip for measurement of a concentration of peracetic acids can have several advantages. Generally, the embodiments relating to a test strip can present an easy to use way of measuring the concentration of peracetic acids or other cleaning and/or disinfecting and/or sterilizing agents in a liquid. For example, the embodiments relating to a test strip can provide a way of measuring the cleaning and/or disinfecting and/or sterilizing agents in a liquid after a pre-determined amount of time. Furthermore, the embodiments relating to a test strip may even be stored in environments usually adversely affecting the test strips in general and the test surface in particular.

According to an embodiment, a method for providing a coating to a test strip for measurement of a concentration of peracetic acids is provided. The method comprising providing a test strip with a test surface configured to react with a liquid, and covering the test surface with a coating.

In the following, details, functions and embodiments of the method and arrangement for providing a coating to a test strip for measurement of a concentration of peracetic acids will be described.

The method for providing a coating to a test strip for measurement of a concentration of peracetic acids can further comprise liquefying a coating material and submerging the test strip into the liquid coating material until the test surface is fully submerged. In this way, the test surface can be fully covered with the coating material.

In a further embodiment, the method for providing a coating to a test strip for measurement of a concentration of peracetic acids can comprise keeping the test surface submerged into the liquid coating material for a predetermined period of time and/or extracting the test strip from the liquid coating material and/or drying the liquid coating. This embodiment can have the advantage of thoroughly and evenly covering the test surface with the coating material.

The method for providing a coating to a test strip for measurement of a concentration of peracetic acids can comprise applying a coating in the form of a foil to at least a portion of one side of the test strip, such as a portion of the side of the test strip containing the test surface, which can occur in an assembly line production, such as in an semi-automatic or fully automatic assembly line production. This can have the advantage of fully covering the test surface with the coating material without risking heat-related damage to the test strip.

Further embodiments of the method and test strips described above can be realized by combining some or all of the features described herein.

According to an embodiment, an assembly line configured to provide test strips for measurement of a concentration cleaning and/or disinfecting and/or sterilizing agents in a liquid, such as peracetic acids according to one or more embodiments as described above is also provided. Embodiments of the test strip in which the coating covers at least a portion of the test strip surrounding the test surface, or in which the coating covers at least a portion of the side of the test strip containing the test surface, or in which the coating covers all sides of the test strip along a length section of the test strip containing the test surface can be produced in the same assembly line. This can include either covering the test surface by keeping the test surface submerged into the liquid coating material for a predetermined period of time or by applying a coating in the form of a foil to at least a portion of one side of the test strip containing the test surface resulting in any of the embodiment described above.

As to the advantages, embodiments and details of the individual different aspects and their embodiments, reference is also made to the corresponding advantages, embodiments and details described with reference to the respective other aspects.

Further embodiments can result from the combination of individual, several or all of the features described herein.

### BRIEF DESCRIPTION OF THE DRAWINGS

The embodiments shall now be described with reference to the attached drawings, in which:

FIG. 1 illustrates a schematic depiction of an exemplary prior art reprocessing apparatus for medical instruments;

FIG. 2 illustrates a schematic depiction of an exemplary embodiment of a reprocessing apparatus for medical instruments;

FIG. 3 illustrates a schematic depiction of an arrangement for measuring a concentration of reprocessing agents in a reprocessing liquid used in the reprocessing apparatus for medical instruments of FIG. 2 in more detail;

FIG. 4a-c illustrate cross-sections of three embodiments of a test strip for measurement of a concentration of peracetic acids;

FIG. 5 illustrates a three-dimensional view of a first embodiment according to FIG. 4a;

FIG. 6 illustrates a three-dimensional exploded view of a second embodiment according to FIG. 4b;

FIG. 7 illustrates a three-dimensional view of a third embodiment according to FIG. 4c; and

FIG. 8 illustrates a schematic flow diagram of a method for providing a coating to a test strip for measurement of a concentration of peracetic acids.

### DETAILED DESCRIPTION

In the Figures, elements with the same or comparable functions are indicated with the same reference numerals.

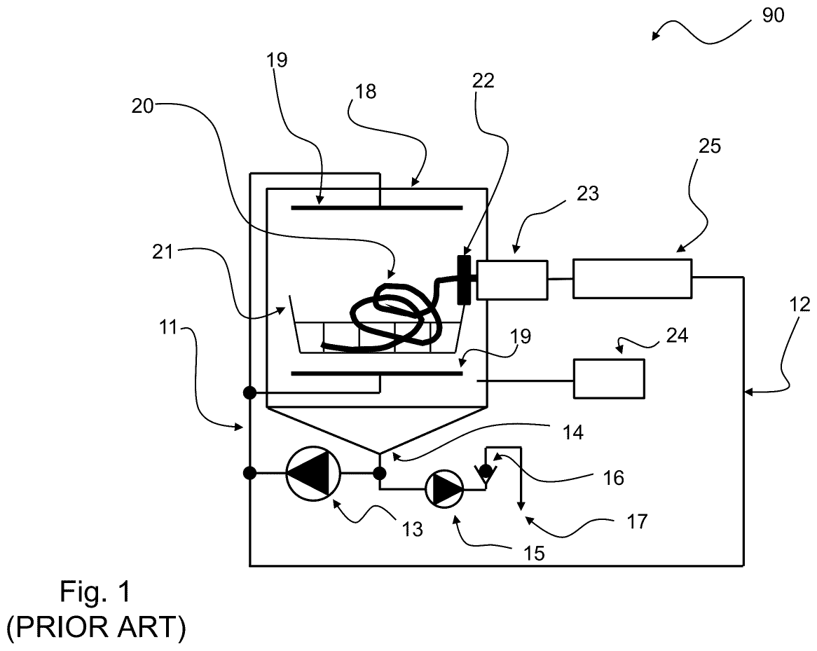

FIG. 1 shows a schematic layout of an exemplary prior art reprocessing apparatus 90 for medical instruments 20, for example endoscopes. The apparatus 90 may comprise a reprocessing chamber 18, in which a loading carrier 21 containing medical instruments 20 to be cleaned and/or disinfected and/or sterilized may be placed. Reprocessing liquid may be circulated in the apparatus 90 via circulation pump 13 and pump sump 14 in an outer reprocessing circuit 11 and an inner reprocessing circuit 12. The outer reprocessing circuit 11 may circulate the reprocessing liquid in the processing chamber 18 via at least one, such as, two spray arms 19, as shown in FIG. 1. The inner reprocessing circuit 12 may circulate the reprocessing liquid via monitoring unit 25, loading carrier 21 and loading carrier coupling 23 to the inner channels of medical instruments 20 located in loading carrier 21. A dosing system 24 may be provided for dosing reprocessing agents to the reprocessing liquid in the reprocessing chamber 18. Pump sump 14 may be connected to a drain pump 15, which in turn may be connected to a check valve 16 and a structural drain 17.

The inner reprocessing circuit 12 connects the loading carrier 21 to the structural drain 17. The inner reprocessing circuit 12 may comprise a monitoring unit 25, which may be connected to the loading carrier 21 via a loading carrier coupling 23 comprising an adapter plate 22. The monitoring unit 25 may further be connected to the circulation pump 13, and thus to the subsequent elements following the circulation pump, namely the drain pump 15, the check valve 16, and the structural drain 17. The monitoring unit can be a “flow control,” which can be a dedicated module that monitors for blockages and dropped adapters. Such monitoring can operate by analyzing pressure differences. The values of which can be communicated via a so-called type list. The monitoring unit therefore also includes sensors, such as pressure sensors.

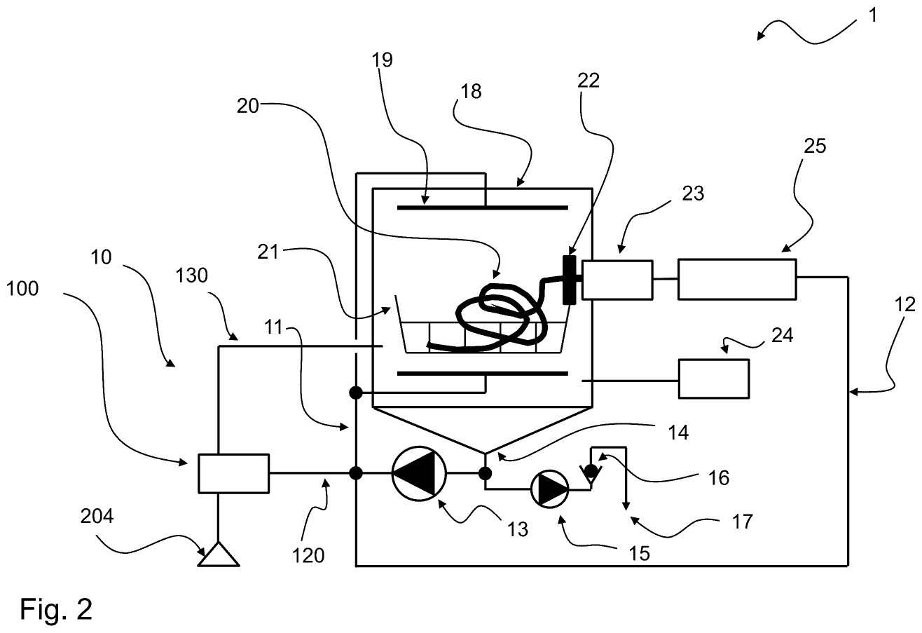

FIG. 2 shows a schematic layout of an exemplary embodiment of a reprocessing apparatus 1 for medical instruments 20, for example endoscopes. Also reprocessing apparatus 1 may comprise a reprocessing chamber 18, in which a loading carrier 21 containing medical instruments 20 to be cleaned and/or disinfected and/or sterilized may be placed. Reprocessing liquid may be circulated in the reprocessing apparatus 1 via circulation pump 13 and pump sump 14 in an outer reprocessing circuit 11 and an inner reprocessing circuit 12. The outer reprocessing circuit 11 may circulate the reprocessing liquid in the processing chamber 18 via least one, such as two spray arms 19. The inner reprocessing circuit 12 may circulate the reprocessing liquid via monitoring unit 25, loading carrier 21 and loading carrier coupling 23 to the inner channels of medical instruments 20 located in loading carrier 21. A dosing system 24 may be provided for dosing reprocessing agents to the reprocessing liquid in the reprocessing chamber 18. Pump sump 14 may be connected to a drain pump 15, which in turn may be connected to a check valve 16 and a structural drain 17.

The inner reprocessing circuit 12 connects the loading carrier 21 to the structural drain 17. The inner reprocessing circuit 12 may comprise a monitoring unit 25, which may be connected to the loading carrier 21 via a loading carrier coupling 23 comprising an adapter plate 22. The monitoring unit 25 may further be connected to the circulation pump 13, and thus to the subsequent elements following the circulation pump, namely the drain pump 15, the check valve 16, and the structural drain 17.

The reprocessing apparatus 1 differs from existing reprocessing apparatus 90 for example in an arrangement (apparatus) 10 for measuring a concentration of reprocessing agents in a reprocessing liquid and a compressed air supply 204.

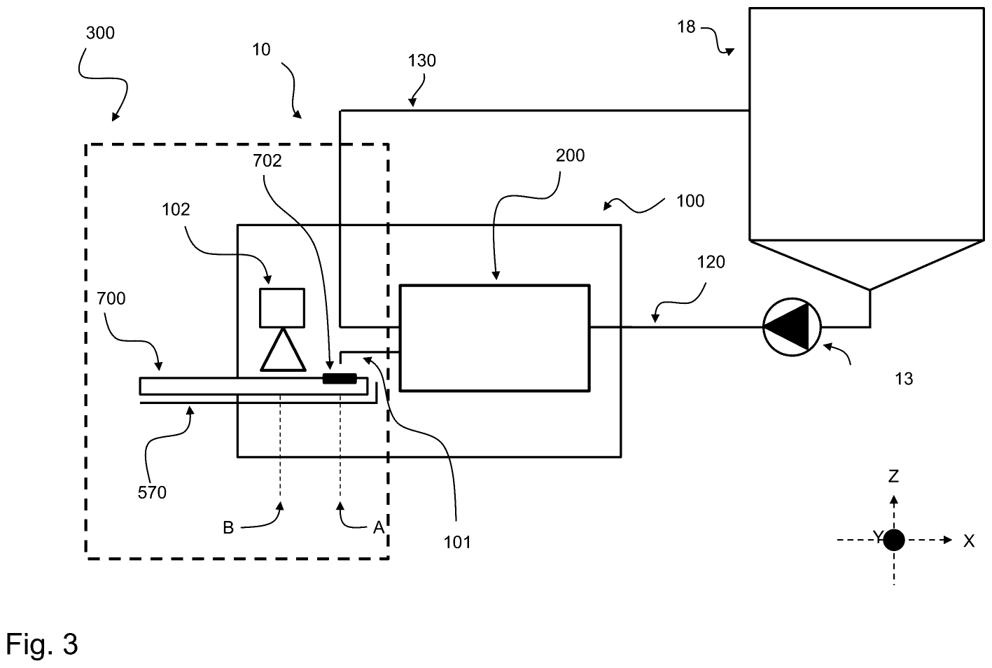

FIG. 3 shows a schematic depiction of an arrangement 10 for measuring a concentration of reprocessing agents in a reprocessing liquid used in the reprocessing apparatus 1 for medical instruments of FIG. 2 in more detail.

The arrangement 10 comprises a measuring system 100 connected to the reprocessing circuits 11, 12, such as to the circulation pump 13, via a first conduit 120 hydraulic connection of the measuring system. Furthermore, the measuring system 100 is connected to the reprocessing chamber 18 via a second conduit 130 for a bypass connection. The first and second conduits can form a bypass circuit for reprocessing liquid to be fed through measuring system 100. The measuring system 100 may be further connected to a compressed air supply 204.

During operation of the apparatus 1, one or several medical instruments 20 are placed into the loading carrier 21 and connected via the adapter plate 22 and the loading carrier coupling 23 to the inner reprocessing circuit 12 for rinsing the inner channel(s) of the medical instrument(s) 20 with reprocessing fluid.

The reprocessing chamber 18 may be filled with reprocessing liquid containing a reprocessing agent using spray arms 19 via the outer reprocessing circuit 11. The reprocessing chamber 18 may hold the reprocessing liquid for a predetermined amount of time. Alternatively and/or additionally, the circulation pump 13 may be used to re-circulate the reprocessing liquid containing the reprocessing agent by pumping it via the circulation pump 13 from the pump sump 14 to the spray arms 19 in the outer reprocessing circuit 11 and/or to the inner channel(s) of the medical instrument(s) 20 in the inner reprocessing circuit 12 for a pre-determined amount of time and/or number of cycles.

During cycling, reprocessing liquid may be taken from the outer reprocessing circuit 11 via the first conduit 120 to supply it to the measuring system 100, in which the concentration of the reprocessing agent in the reprocessing liquid is measured.

Dosing unit 24 may supply additional reprocessing agent according to the measurements of measuring system 100. After measuring the concentration of the reprocessing agent, the remaining reprocessing liquid may be fed back to the outer reprocessing circuit 11 via the second conduit 130.

At the end of a reprocessing procedure, such as after a pre-determined amount of time and/or number of recirculation cycles with a required concentration of reprocessing agents in the reprocessing liquid, the reprocessing chamber 18 may be emptied via the structural drain 17 by using the drain pump 15 for pumping the time liquid through the check valve 16 into the structural drain 17.

The measuring system 100 may be located outside of a housing of the apparatus 1 or may have an interface on an outer periphery of the apparatus 1.

The measuring system 100 is configured to receive a test strip 700 with a test surface 702 and to position the test strip 700 in a first, dosing position A and a second, measuring position B, both located along a test strip guide 570, as can be seen in FIG. 3. The measuring system 100 is further configured to dose a predetermined amount of reprocessing liquid onto the test surface 702 when the test strip 700 is positioned in the first, dosing position A via a reprocessing liquid feed system and a sample feed line 101 connected thereto.

The measuring system 100 can comprise an evaluating unit 102 for measuring the concentration of reprocessing agents in the reprocessing liquid when the test strip 700 is positioned in the second, measuring position B by evaluating the test surface 702. The evaluating unit 102 may comprise an optical spectrometer and/or and RGB color sensor, and the evaluating unit 102 may be configured to compare the evaluation result with a reference value. For example a characteristic, such as a color characteristic, of the test surface 702 may be determined, and compared with a reference characteristic. The predetermined amount of reprocessing liquid may act on the test surface 702 for a predetermined exposure time before evaluating the test surface 702. After evaluating the test surface 702, the test strip 700 is released.

The arrangement 10 for measuring a concentration of reprocessing agents in a reprocessing liquid used in a reprocessing apparatus 1 for medical instruments 20, can further comprise a transport arrangement 300 for transporting a test strip 700. The transport arrangement 300 may be used for transporting a test strip 700. A single test strip 700 can be transported.

The arrangement 10 for measuring a concentration of reprocessing agents in a reprocessing liquid used in a reprocessing apparatus 1 for medical instruments 20, can further comprise a reprocessing liquid feed system 200 for dosing a predetermined amount of reprocessing liquid onto a test surface 702 of a test strip 700.

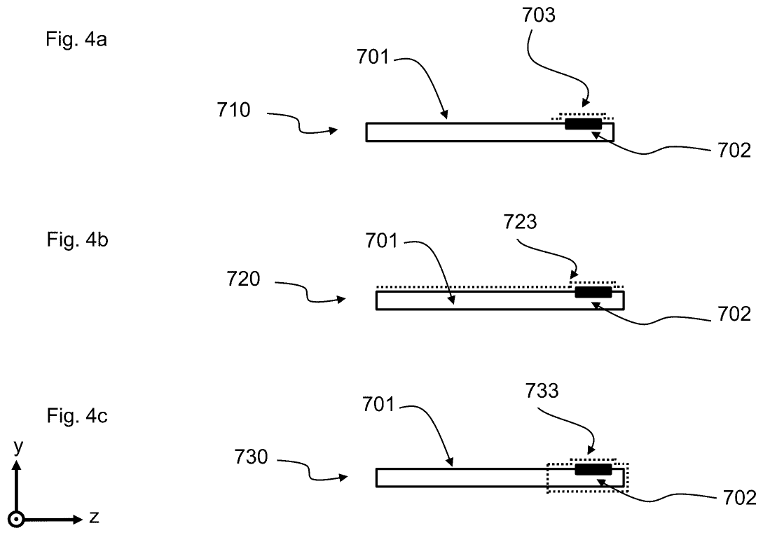

In FIGS. 4a-4c, 5, 6 and 7, three exemplary embodiments 710, 720, 730 of the test strip 700 for measurement of a concentration of peracetic acids are shown. In each embodiment, the test strip for measurement of a concentration of peracetic acids comprises a test strip main body 701, a test surface 702, and a coating 703, 723, 733.

The main body 701 may be made of a suitable material, for example a plastic or cardboard material. The main body 701 may be sized and shaped in a way that allows easy handling by persons or machines supplying the test strip 710, 720, 730. In an embodiment, the main body 701 may be sized such that the test strip 710, 720, 730 may be used in a reprocessing apparatus for medical instruments 100, as shown exemplarily in FIG. 1. For example, various embodiments of the test strip 710, 720, 730 may be used in a measuring system 100 of a reprocessing apparatus for medical instruments 20. The test strip main body 701 may be shaped in any shape suitable for this use. For example, the test strip main body 701 may have the form of a square, a circle, or an oval. In an embodiment, the test strip main body 701 can be rectangular in shape. In an embodiment, the size of the test strip 710, 720, 730 can be optimized for readout by the measuring system 100. The measuring system 100 may comprise, for example, a spectrometer and/or a RGB sensor.

The test surface 702 of the test strip 710, 720, 730 may be made of a material sensitive to active agents in reprocessing liquids, such has cleaning liquids, and/or disinfection liquids, and/or sterilization liquids. In an embodiment, the test surface 702 can be configured to react with peracetic acids contained in a cleaning liquid. A reaction of the test surface 702 can be understood as a change of color of the test surface 702. In an embodiment, the color of the test surface may change depending on the concentration of peracetic acids within a liquid. The test surface 702 may be configured to react with active agents in a reprocessing liquid, such as a cleaning and/or disinfecting and/or sterilizing liquid within a specific period of time.

The test surface 702 may also be configured to react with other active agents used in cleaning and/or disinfection and/or sterilization liquids. For example, the test surface 702 may be configured to react with alcohols, chlorine, iodophores, hydrogen peroxide, quaternary ammonia compounds or other sterilizing and/or disinfecting agents. The test surface 702 may also be configured to indicate the efficacy of steam, ethylene oxide, dry heat, formaldehyde, or other sterilization processes.

The test surface 702 may cover a sufficient part of the test strip main body 701. For example, the test surface 702 may cover at least 5%, at least 10%, at least 15%, at least 20%, at least 25%, at least 30%, or at least 40% of the total length of the test strip. For example, the test surface 702 may cover a maximum of 80%, a maximum of 75%, a maximum of 70%, a maximum of 60%, a maximum of 50%, a maximum of 40%, or a maximum of 30% of the total length of the test strip. The test surface 702 may have a shape suitable for making the results accessible to human users and/or for machine readout. For example, the test surface 702 may be quadratic, rectangular, or circular in shape. The shape and size of the test surface 702 can be optimized for readout by an evaluating unit used in a measuring system 100 of a reprocessing apparatus for medical instruments 20. In an embodiment, the evaluating unit can comprise an optical spectrometer and/or a RGB color sensor. The evaluation unit may be further configured to compare an evaluation result with a reference value.

The test surface 702 may be coupled to the main body 701 of the test strip 710, 720, 730 in various ways. For example, the test surface may be attached to the main body 701 of the test strip 710, 720, 730 using clips, adhesive dots/stripes, liquid glues, or other mounting types. The test surface 702 may also be integrated into the main body 701 of the test strip during the test strip's production.

A coating 703, 723, 733 may cover the test surface 702 of the test strip 710, 720, 730.

The coating 703, 723, 733 can be a foil. The coating 703, 723, 733 may be configured to reduce the reactivity of the test surface with ambient humidity and/or air humidity. The coating 703, 723, 733 may comprise a material that is soluble in liquids. The coating 703, 723, 733 may further comprise a biodegradable material. For example, the coating 703, 723, 733 may comprise pullulan, carrageenan, or arabinoxylan. In an embodiment, the coating 703, 723, 733 can comprise polyvinyl alcohol or a material based on polyvinyl alcohol. In an embodiment, the coating 703, 723, 733 can be soluble in liquids, such as water or liquids containing a substantial amount of water. The coating 703, 723, 733 may be configured to be submerged in liquids, such as water or liquids containing a substantial amount of water, for extended periods of time before dissolving.

As will be described in the following, the coating 703, 723, 733 may also be configured to furthermore cover a substantial amount of the main body 701 of the test strip 710, 720, 730.

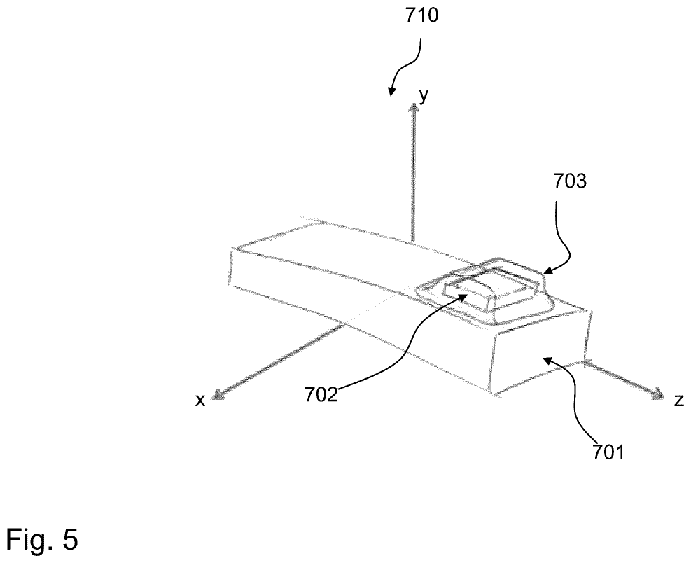

FIGS. 4a and 5 show a first embodiment 710 of a test strip. FIG. 4a shows a cross-section view of the first embodiment 710, while FIG. 5 shows a three-dimensional view of the first embodiment 710. This first embodiment 710 comprises a main body 701, a test surface 702 connected to one side of the main body, and a coating 703. In this embodiment, the coating 703 may cover the test surface 702 and at least a portion of the main body 701, such as a portion of the main body 701 surrounding the test surface 702. For example, the coating 703 may cover the test surface 702 and a portion surrounding the test surface 702.

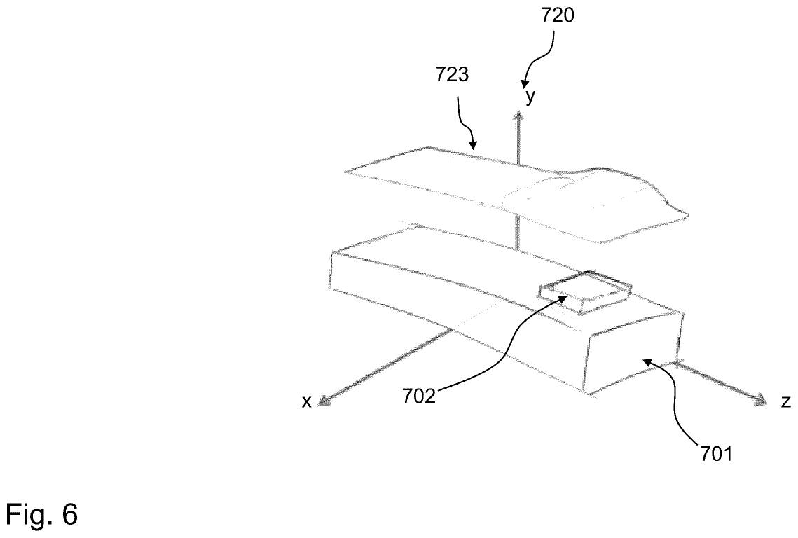

FIGS. 4b and 6 show a second embodiment 720. FIG. 4b shows a cross-section view of the second embodiment 720, while FIG. 6 shows an exploded three-dimensional view of the second embodiment 720. This second embodiment 720 comprises a main body 701, a test surface 702 connected to one side of the main body, and a coating 723. In this embodiment 720, the coating 723 may cover the test surface 702 and at least a portion of the main body 701, such as a substantial portion of the side of the main body containing the test surface 702. For example, the coating may cover at least 50%, at least 60%, at least 70%, or at least 90% of the side of the test strip's main body, including the test surface 702. In an embodiment, the coating 723 can substantially cover the whole side of the test strip's main body 701 including the test surface 702.

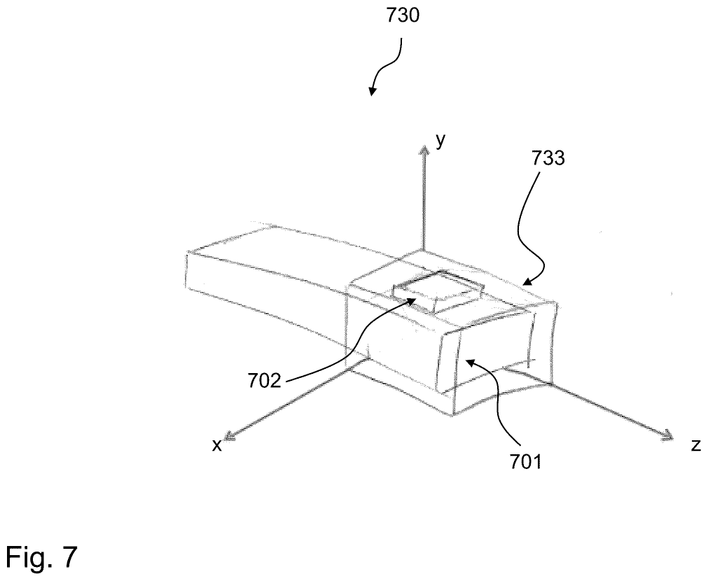

FIGS. 4c and 7 show a third embodiment 730. FIG. 4c shows a cross-section view of the third embodiment 730, while FIG. 7 shows a three-dimensional view of the third embodiment 730. This third embodiment 730 comprises a main body 701, a test surface 702 connected to one side of the main body, and a coating 733. In this embodiment 730, the coating 733 may cover the test surface 702 and at least a portion of the main body 701, such as a substantial portion of all sides of the main body along a length section of the main body 701 containing the test surface 702. For example, the coating may cover at least 60%, at least 70%, or at least 90% of main body 701 including the test surface 702. In an embodiment, the coating can substantially cover 50% of test strip's main body 701 including the test surface 702. In another embodiment, the coating 733 can cover the whole test strip 720, such as all sides of the whole test strip 720.

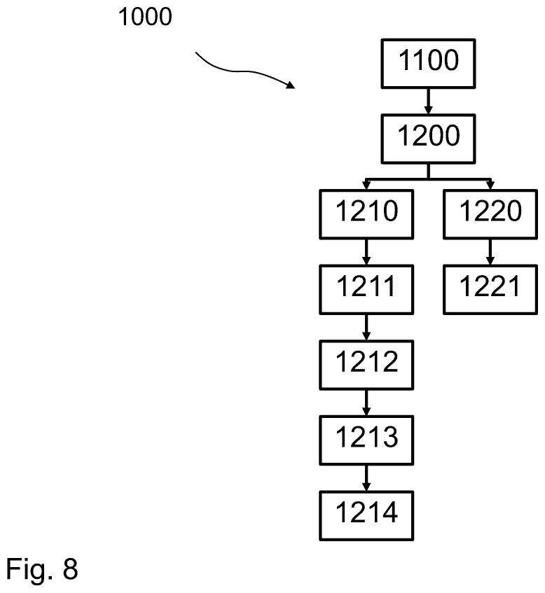

FIG. 8 shows a schematic flow diagram of a method 1000 for providing a coating 703, 723, 733 to a test strip 700, 710, 720, 730 for the measurement of a concentration of peracetic acids. The method 1000 may comprise the step 1100 of providing a test strip main body 701 comprising a test surface 702 configured to react with a liquid containing at least traces of reprocessing agents, such as cleaning and/or disinfecting and/or sterilizing agents. The test strip 700, 710, 720, 730 may be of any shape and size as described herein above.

The method 1000 may further comprise the step 1200 of covering at least the test surface 702 with a coating 703, 723, 733.

In an embodiment, such as resulting in embodiment 730, the method 1000 may further comprise the step 1210 of liquefying the coating material.

The coating material may be any material suitable to cover the test surface 702 as specified earlier herein above. The coating material can comprise a liquid soluble material, such as a water soluble material. Furthermore, the coating 703, 723, 733 may comprise a biodegradable material. In an embodiment, the coating material may comprise polyvinyl alcohol.

In order to liquefy the coating material, the coating material may be heated to temperatures of at least 200° C. The coating material may then be kept at suitable elevated temperatures for extended periods of time.

The method 1000 may further comprise the step 1211 of submerging the test strip into the liquefied coating material until the test surface 702 is fully submerged. Submerging may be performed by any suitable means, for example by manual submergence or machine controlled immersion. The test strip may be submerged into the liquefied coating material by machine controlled immersion. For example, the test strip main body 701 comprising the test surface 702 may be submerged until at least 5%, at least 10%, at least 15%, at least 20%, at least 25%, at least 30%, or at least 40% of the total length of the test strip main body 701 including the part containing the test surface 702 is submerged in the liquefied coating material. In another example, the test strip main body 701 comprising the test surface 702 may be submerged until a maximum of 80% of the total length of the test strip, a maximum of 75%, a maximum of 70%, a maximum of 60%, a maximum of 50%, a maximum of 40%, or a maximum of 30% of the total length of the test strip main body 701 including the part containing the test surface 702 is submerged in the liquefied coating material. In another embodiment, only the side of the test strip body 701 containing the test surface 702 may be submerged into the liquefied coating material.

The method 1000 may further comprise the step 1212 keeping the test surface 702 submerged into the liquid coating material for a predetermined period of time. The predetermined period of time may be chosen such that the test surface 702 is thoroughly covered with the liquefied coating material.

The method 1000 may further comprise the step 1213 extracting the test strip main body 701 comprising the test surface 702 from the liquid coating material. Extracting the test strip main body 701 from the liquefied coating material may be performed manually or by using machine controlled extraction. The test strips may be extracted using machine controlled extraction.

The liquefied coating material may also be dropped with suitable means onto the test surface 702 of the test strip main body 701, such that the liquefied coating may cover the test surface 702 and at least a portion of the main body 701, such as a portion of the main body 701 surrounding the test surface 702. Suitable means for dropping the liquefied coating material may include syringes, pipets, squeeze bottles, or other suitable means for delivering predetermined amounts of liquefied coating material onto the test surface 702 of the test strip.

The method 1000 may further comprise the step 1214 of drying the liquid coating material after extraction from the liquefied coating material or after dropping the liquefied coating material onto the test surface. For example, the liquid coating material may be air dried or dried in a dry gas. Drying the liquid coating material of the test strip may take a predetermined amount of time.

The steps 1210 through 1214 of the method 1000 may result in test strips according to the embodiment 730. However, test strips according to embodiments 710 and 720 may also be produced with steps 1210 through 1214 of method 1000.

In a further embodiment, alternatively or additionally to the steps 1210 through 1214, the method 1000 may comprise the step 1220 of applying the coating 703 in the form of a foil to at least a portion of one side of the test strip main body 701, such as a portion of the side of the test strip main body 701 containing the test surface 702. In an embodiment 710, the foil may be placed onto the test surface 702 and a portion of the main body surrounding the test surface 702. In another embodiment 720, the foil may be placed on the side of the test strip's main body containing the test surface 702. For example, the foil may cover at least 5%, at least 10%, at least 15%, at least 20%, at least 25%, at least 30%, or at least 40% of the total length of the test strip including the test surface 702. For example, the foil may cover a maximum of 80%, a maximum of 75%, a maximum of 70%, a maximum of 60%, a maximum of 50%, a maximum of 40%, or a maximum of 30% of the total length of the test strip including the test surface 702. The foil can cover the whole side of the of the test strip main body 701 including the test surface 702. In a further example, the foil may be wrapped around the test strip, either manually or by using suitable machinery.

Step 1200 of the method 1000 may further comprise the step 1221 of affixing the foil to the test strip's main body 701. For example, the foil may be affixed to the main body 701 of the test strip main body 701 by adhesive force alone, or by using clips, adhesive dots/stripes, liquid glues, other methods of affixing . . .

The method 1000 can be performed in a line production, such as in an semi-automatic or fully automatic assembly line production. In an embodiment, steps 1220 through 1221 of the method 1000 can be performed in an assembly line production, such as in a semi-automatic or fully automatic assembly line production.

While there has been shown and described what is considered to be embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

What is claimed is:

1. A test strip for measurement of a concentration of peracetic acids, the test strip comprising:
a body;
a test surface disposed on the body and configured to react with a liquid containing peracetic acids; and
a coating covering at least the test surface.

2. The test strip according to claim 1, wherein the coating is configured to reduce the reactivity of the test surface with one or more of ambient humidity and air humidity.

3. The test strip according to claim 1, wherein the coating is a foil.

4. The test strip according to claim 1, wherein one or more of:
the coating comprising a liquid soluble material; and
the coating comprising a biodegradable material.

5. The test strip according to claim 4, wherein the liquid soluble material is a water soluble material.

6. The test strip according to claim 1, wherein the coating comprising polyvinyl alcohol.

7. The test strip according to claim 1, wherein the coating covers at least a portion of one side of the body.

8. The test strip according to claim 7, wherein the coating covers at least a portion of a side of the body containing the test surface.

9. The test strip according to claim 1, wherein the coating covers at least a portion of the body surrounding the test surface.

10. The test strip according to claim 1, wherein the coating covers all sides of the body along a length section of the body containing the test surface.

11. The test strip according to claim 10, wherein the length section of the body covered by the coating is between 5% and 40% of the total length of the test strip.

12. The test strip according to claim 10, wherein the length section of the body covered by the coating is between 30% and 80% of the total length of the test strip.

13. The test strip according to claim 1, wherein the coating covers the whole body.

14. A method for providing a coating to a test strip for measurement of a concentration of peracetic acids, the method comprising:
providing a test strip main body with a test surface disposed on the test strip main body and configured to react with a liquid; and
covering the test surface with a coating.

15. A method according to claim 14, wherein the covering further comprises:
liquefying a coating material; and
submerging the test strip main body into the liquid coating material until at least the test surface is fully submerged.

16. The method according to claim 15, further comprising keeping at least the test surface submerged into the liquid coating material for a predetermined period of time.

17. The method according to claim 15, further comprising:
extracting the test strip main body from the liquid coating material; and
drying the liquid coating material.

18. The method according to claim 14, further comprising applying the coating in the form of a foil to at least a portion of one side of the test strip main body in one of a semi-automatic or fully automatic assembly line production.

19. The method according to claim 18, wherein the at least the portion of the one side of the test strip main body comprises a portion of a side of the test strip main body containing the test surface.
